(19) United States
(12) Patent Application Publication
(10) Pub. No.: US 2011/0029621 A1
(43) Pub. Date: Feb. 3, 2011

(54) MAIL SERVER SYSTEM AND CONGESTION CONTROL METHOD

(76) Inventors: Toshiyuki KAMIYA, Yokohama (JP); Takafumi Koike, Kawasaki (JP); Toshifumi Kusume, Yokosuka (JP); Masafumi Kinoshita, Sagamihara (JP); Koji Tanaka, Yokohama (JP)

Correspondence Address: ANTONELLI, TERRY, STOUT & KRAUS, LLP, 1300 NORTH SEVENTEENTH STREET, SUITE 1800, ARLINGTON, VA, 22209-3873, US

(21) Appl. No.: 12/779,323

(22) Filed: May 13, 2010

(30) Foreign Application Priority Data
Jun. 10, 2009 (JP) 2009-138956

(51) Int. Cl. G06F 15/16

(52) U.S. Cl. 709/206; 709/235

(57) ABSTRACT

A mail server system includes a congestion control management section managing a congestion control over the mail server system, a congestion statistical information collection section collecting the congestion statistical information of each mail server, and a resend queue having enough capacity, wherein a retry server for performing a retry process is provided. The congestion control management section detects the mail server where a fault occurs from the collected congestion statistical information and gives an instruction of regulating the sending of a mail directed to the faulty mail server to each mail server. The mail server instructed the regulating the sending of the mail directed to the faulty mail server transfers all the mails directed to that destination to the retry server, and transfers the received mail directed to the faulty mail server to the retry server until there is a regulation dissolution instruction from the congestion control management section.

### CLAIM OF PRIORITY

The present application claims priority from Japanese patent application JP 2009-138956 filed on Jun. 10, 2009, the content of which is hereby incorporated by reference into this application.

### BACKGROUND OF THE INVENTION

1. Field of the Invention

The present invention relates to a mail server system and a congestion control method, and more particularly to a mail server system for providing a service of allowing a carrier to send a mail from a subscribing user to the other carrier or other user and its congestion control method. In more detail, the invention is concerned with a system and method for performing the congestion control efficiently if a fault occurs in the other mail server at a destination or communication path.

2. Description of the Related Art

In a conventional mail server system for electronic mail (hereinafter mail), which is redundantly composed of a plurality of mail servers, if a fault occurs in a path leading to a sending destination mail server or the sending destination mail server, the individual mail servers perform the congestion control. Each mail server individually performs a retry process for message stored in a resend queue to check a congestion state, and make a determination for resolving the fault. In this kind of mail server congestion control, the mail server has a send queue and a resend queue that stores a mail which failed in sending, and performs the congestion control while sharing a thread resource within the server between normal sending and resending, as disclosed in JP-A-2005-269263 (Japanese Patent Application No. 2004-79000). Also, each server has a congestion state control section, and restricts the number of mails received from a client and the number of mails sent to a destination mail server in accordance with the actual results of the number of mail transmission, as disclosed in Japanese Patent Application No. 9-230607 (JP-A-11-65961) (mail sending/receiving apparatus and mail sending/receiving method).

### SUMMARY OF THE INVENTION

In a conventional mail server system, if a fault occurred in a specific sending destination mail server or path, a resource within each mail server was employed for resending a mail to the mail server and checking a congestion state, possibly having influence on the processing ability of a send queue in each mail server, whereby in some cases the mail server resource could not be effectively utilized in the overall system. Also, if it takes a long time to resolve the fault in the specific sending destination mail server or path, the mail that could not be sent is left in the resend queue. Even after resolving the fault, the processing for the resend queue has some influence on the processing ability of the send queue. On the other hand, if control was made not to have influence on the processing ability of the send queue, there was a delay in clearing away the residence in the resent queue, resulting in a problem that it took a long time to have no residence after resolving the fault.

Also, there is a method for regulating transmission from a client of a mail directed to a main server where a fault has occurred to prevent residence from occurring, but there was a problem that the service for a subscribing user was degraded.

Also, a mail server system is connected to a sending destination mail server (system) via the internet, whereby it is supposed that some destination mail servers have high reliability with sufficient countermeasures against the occurrence of fault, but the others are not too high in reliability and relatively likely to cause a fault. In such system, it is not preferable that if a fault occurs in the latter server and the resend processing for the mail increases, the former destination server with high reliability to send a mail is affected.

In the light of the above points, it is an object of the invention to provide a mail server system and a congestion control method in which if a fault occurs in a specific sending destination mail server or path, a mail server resource can be effectively utilized in the overall system to have less influence on the processing ability of the send queue. Also, it is another object of the invention to shorten the time of clearing away the residence of mail in the resend queue after resolving a fault. Further, it is another object of the invention to provide a system configuration and method in which the mail sending regulation for a subscribing user is not made as much as possible.

In order to accomplish the above object, the invention has a congestion control management section for managing a congestion control over the mail server system, a congestion statistical information collection section for collecting the congestion statistical information of each mail server, and a resend queue having enough capacity, wherein a retry server for performing a retry process is set up.

Also, in the invention, the congestion statistical information collection section of each mail server has a function of collecting the mail send congestion statistical information for each destination mail server, and sending it to the congestion control management section.

Also, in the invention, the congestion control management section has a function of detecting the mail server where a fault occurs from the collected congestion statistical information and giving an instruction of regulating the sending of a mail directed to the faulty mail server to each mail server.

Also, in the invention, the mail server given the instruction of regulating the sending of a mail directed to the faulty mail server has a function of transferring all the mails directed to that destination to the retry server, and not sending a mail to the faulty mail server until there is a regulation dissolution instruction from the congestion control management section.

Also, in the invention, only the retry server has a function of retrying sending of a mail to the faulty mail server, sending the congestion statistical information to the congestion control management section, and sending an instruction of dissolving the mail sending regulation for a mail directed to the faulty mail server to each mail server if the congestion control management section detects a recovery of the faulty mail server.

According to the first solving means of this invention, there is provided a mail server system comprising:

a plurality of mail servers which are redundantly configured and sends a received electronic mail according to a destination thereof;

a retry server for performing a resend process for the electronic mail transferred from the mail servers; and

a congestion control management section for judging whether or not to regulate a sending by comparing response time information or a ratio of the number of errors to the number of mail sending trial with a preset threshold, based on the congestion statistical information received for each destination domain, and sending a sending regulation instruction including the destination domain to each of the plurality of mail servers in a case of regulating the sending;

each of the plurality of mail servers having:

a statistical information collection section for collecting the response time information of the destination domain and/or the error ratio information including the number of mail sending trail and the number of errors for each destination domain of electronic mail, and sending the congestion statistical information including the response time information and/or the error ratio information to the congestion control management section; and

a congestion control section for receiving a sending regulation instruction from the congestion control management section and transferring an electronic mail directed to the destination domain included in the sending regulation instruction to the retry server.

According to the second solving means of this invention, there is provided a congestion control method in a mail server system which comprises a plurality of mail servers which are redundantly configured and sends a received electronic mail according to a destination thereof and, a retry server for performing a resend process for the electronic mail transferred from the mail servers, the congestion control method comprising steps of:

collecting, by a mail server, the response time information of the destination domain and/or the error ratio information including the number of mail sending trail and the number of errors for each destination domain of electronic mail, and sending the congestion statistical information including the response time information and/or the error ratio information;

judging whether or not to regulate a sending by comparing response time information or a ratio of the number of errors to the number of mail sending trial with a preset threshold, based on the congestion statistical information received for each destination domain, and sending a sending regulation instruction including the destination domain to each of the plurality of mail servers in a case of regulating the sending;

receiving, by the mail server, the sending regulation instruction and transferring an electronic mail directed to the destination domain included in the sending regulation instruction to the retry server; and

performing, by the retry server, the resend process for the electronic mail transferred.

According to the invention, if a fault occurs in a specific destination mail server, a retry process for a mail required to resend and monitoring of the recovery state of a faulty mail server are not performed in each mail server, whereby the overall system resource can be effectively utilized.

Also, according to the invention, a retry server having no send queue for a normal mail can only resend a mail after recovery of the faulty mail server, whereby the mail can be resent without having influence on the send queue processing performance of each server, and the residence can be cleared away promptly.

Also, according to the invention, since a sending delay to the faulty mail server can be absorbed by the resend queue having enough capacity in the retry server, if a fault occurrence interval is short, the congestion control can be performed without regulating mail sending for a subscribing user.

### BRIEF DESCRIPTION OF THE DRAWINGS

FIG. 1 is a system configuration block diagram showing an embodiment of the invention.

FIG. 2 is a sequence diagram for congestion control in this mail server system in the case where a fault occurs in a destination mail server of the other system.

FIG. 3 is a sequence diagram for congestion control in this mail server system in the case where the fault in the destination mail server of the other system is resolved.

FIG. 4 is a flowchart for receiving the congestion statistical information in a congestion control management section in FIGS. 2 and 3.

FIG. 5 is a flowchart for receiving a congestion control instruction in a congestion control section in FIGS. 2 and 3.

FIG. 6 is a data organization diagram for congestion statistical information in this mail server system.

FIG. 7 is a data organization diagram for the congestion control instruction in this mail server system.

FIG. 8 is a data organization diagram in a regulation information storage section.

### DESCRIPTION OF THE EMBODIMENT

An embodiment of the invention will be described below in detail with reference to the drawings.

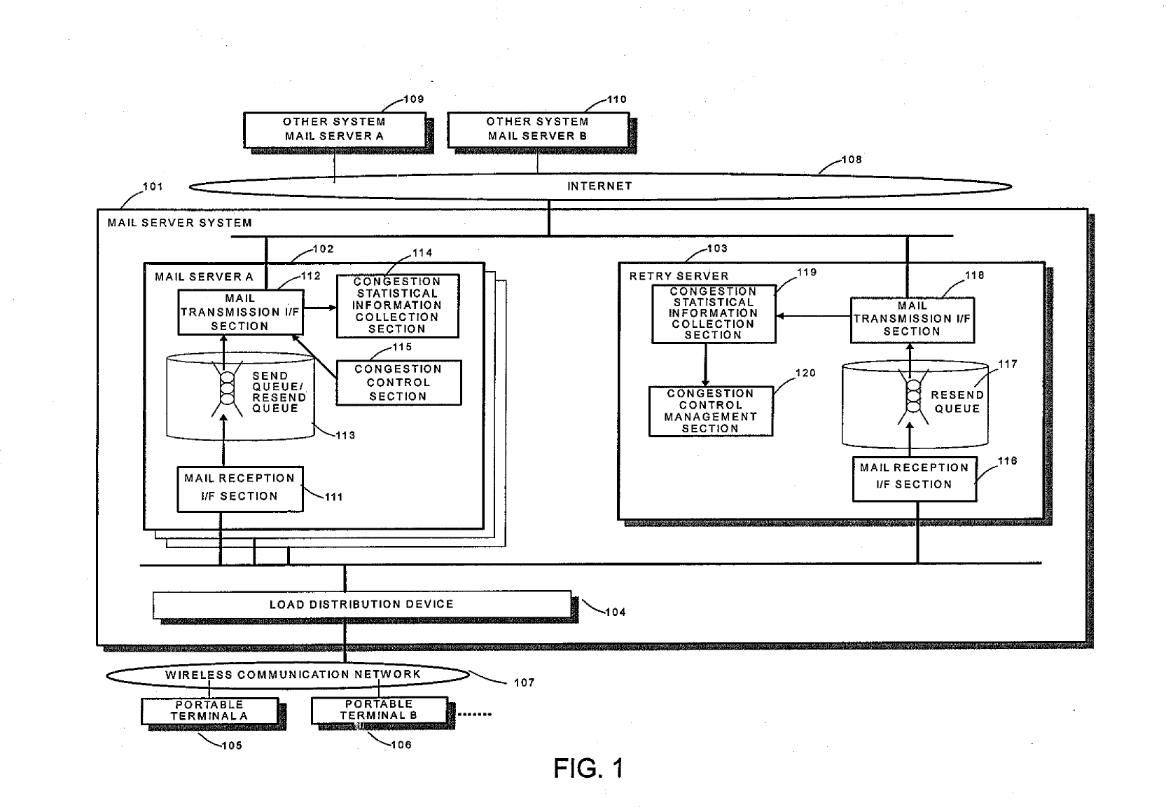

FIG. 1 is a block diagram of a mail server system according to this embodiment.

In FIG. 1, reference numeral 101 denotes a mail server system, reference numeral 102 denotes a plurality of mail servers made redundant by N+1 (N is an integer), reference numeral 103 denotes a retry server, reference numeral 104 denotes a load distribution device for distributing the load of a mail send request over the mail servers 102, reference numerals 105 and 106 denote a portable telephone capable of sending the mail which is owned by a subscribing user, reference numerals 109 and 110 denotes a mail server of the other system to which a mail is sent, reference numeral 107 denotes a wireless communication network for connecting the portable telephones 109 and 110 to the mail server system 101, and reference numeral 108 denotes a network such as Internet for connecting the mail server system 101 to the mail server 109 or 110 of the other system. The wireless communication network 107 may be a wire communication network. Also, the portable telephones 105 and 106 may be appropriate terminals.

The redundant mail server A102 includes a mail reception I/F section 111, a send queue/resend queue 113, a mail transmission I/F section 112, a congestion statistical information collection section 114, and a congestion control section 115. The configuration of the redundant other mail servers 102 is also the same. The retry server 103 includes a mail reception I/F section 116, a resend queue 117, a mail transmission I/F section 118, a congestion statistical information collection section 119, and a congestion control management section 120. The mail transmission I/F section 112 and the mail reception I/F section 116, the congestion statistical information collection section 114 and the congestion control management section 120, and the congestion control management section 120 and the statistical information control section 115 can make the communication via the network, for example. Though the congestion control management section 120 is set in the retry server 103 in this embodiment, it does not matter that the setting location may be in the retry server 103, the mail server 102 or any other server. Also, it does not matter that the retry server may be additionally held by any of the plurality of mail servers 102.

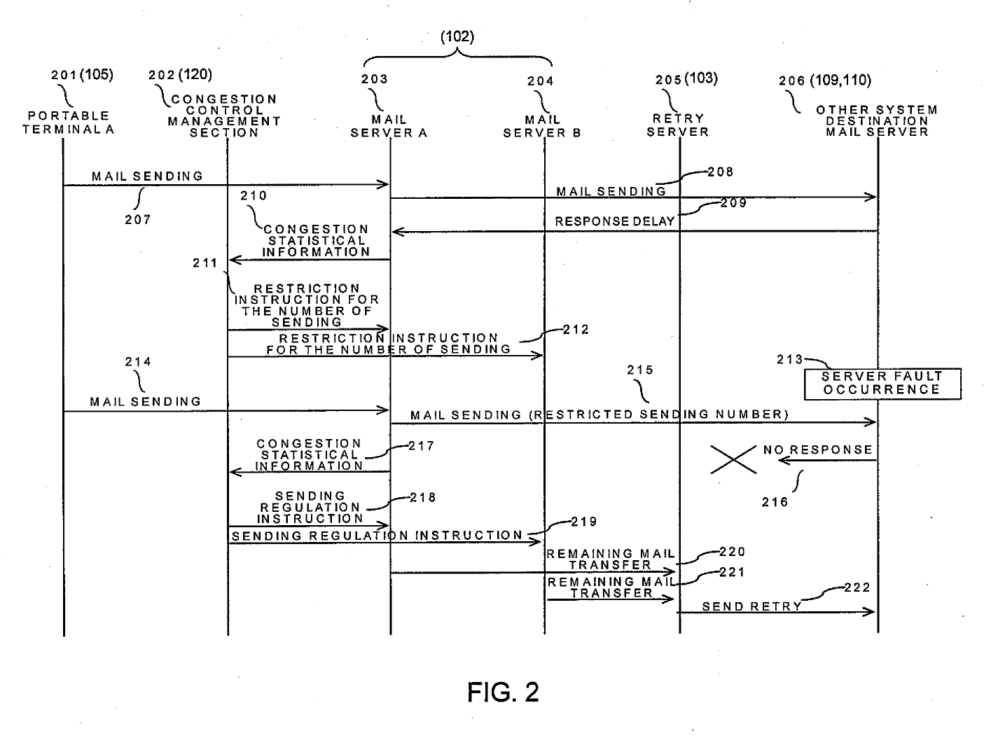

A congestion control with this mail server system in the case where a fault occurs in the destination mail server of the other system will be described below in accordance with a sequence of FIG. 2.

A mail server A203 (corresponding to 102 of FIG. 1) having accepted a mail 207 sent from a portable telephone A201 sends a mail 208 to the mail server 206 of the other system designated as the mail destination. Herein, if the other system mail server 206 becomes in a congested state, causing a response delay 209, the congestion statistical information collection section 114 of the mail server A203 sends the congestion statistical information 210 to the congestion control management section 202 of the retry server 205 (corresponding to 103 in FIG. 1).

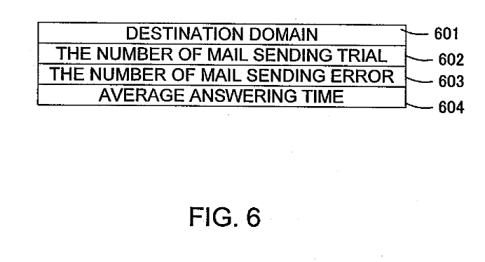

FIG. 6 shows an explanatory view of the congestion statistical information 210. The congestion statistical information 210 includes an average answering time 604 for each destination domain 601, the number of mail sending trail 602 per unit time, and the number of mail sending error 603. The number of mail sending trail 602 is the number that the mail server 102 or retry server 103 retries sending of a mail to the mail server 109 or 110 at a destination. The number of mail sending error 603 is the number that sending a mail was tried but a normal response could not be received. The average answering time is the mean of the response time of an SMTP command, for example. The response time may be the time from the start to the end of a command for sending a mail, or the mean of response time to a predetermine command. The statistical information 210 is collected by both the congestion statistical information collection section 114 of the mail server 102 and the congestion statistical information collection section 119 of the retry server 103.

Turning back to the explanation for the processing of FIG. 2, the congestion control management section 202 (corresponding to 120 in FIG. 1) having received the congestion statistical information 210 determines the congestion control for each destination mail server. If a delay in the response time, or the ratio of the number of mail sending error to the number of mail sending trail exceeds a threshold 1 (second threshold) of regulating the sending restriction, a restriction instruction for the number of sending 211 or 212 is sent to all the mail servers 203 to 204. The restriction instruction for the number of sending 211 or 212 includes the destination domain information, regulation type indicating the restricted sending number, and restricted sending number value, for example.

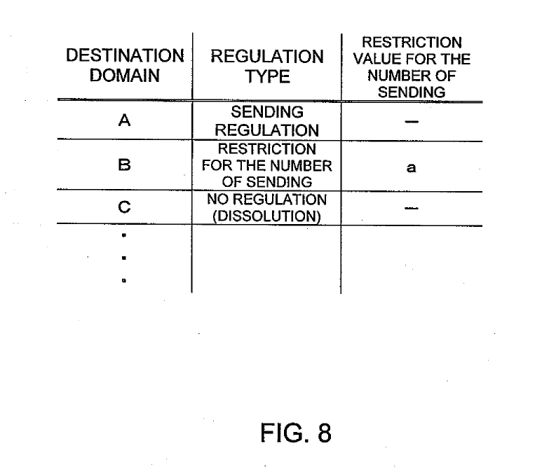

The mail server 203 or 204 stores each information included in the received restriction instruction for the number of sending in a regulation information storage section (FIG. 8). The mail server 203 or 204 having received the restriction instruction for the number of sending then receives the sent mail 214, and sends a mail 215 by restricting the mail sending number per unit time for the instructed other system destination mail server 206 to the instructed restricted value (e.g., predetermined sending number).

If a fault 213 occurs in a destination mail server, a delay in the response time of the congestion statistical information 217, or the ratio of the number of mail sending error to the number of mail sending trail reaches a threshold 2 (first threshold) for regulating the sending restriction, the congestion control management section 202 sends a mail sending regulation instruction 219 to the mail server 203 or 204. It should be noted that the threshold 2 is greater than the threshold 1, and each threshold is predetermined. Also, the threshold for the average answering time and the threshold for the ratio of the number of mail sending error to the number of mail sending trail may be different values. The mail sending regulation instruction includes the destination domain information and the regulation type indicating the sending regulation, for example.

The mail server 203 or 204 stores each information included in the received mail sending regulation instruction in the regulation information storage section (FIG. 8). The mail server 203 or 204 having received the mail sending regulation instruction transfers 220 or 221 all the mails directed to the instructed destination domain, which are left in the queue 113, to the retry server 205. The retry server 205 retries sending 222 to the destination mail server 206.

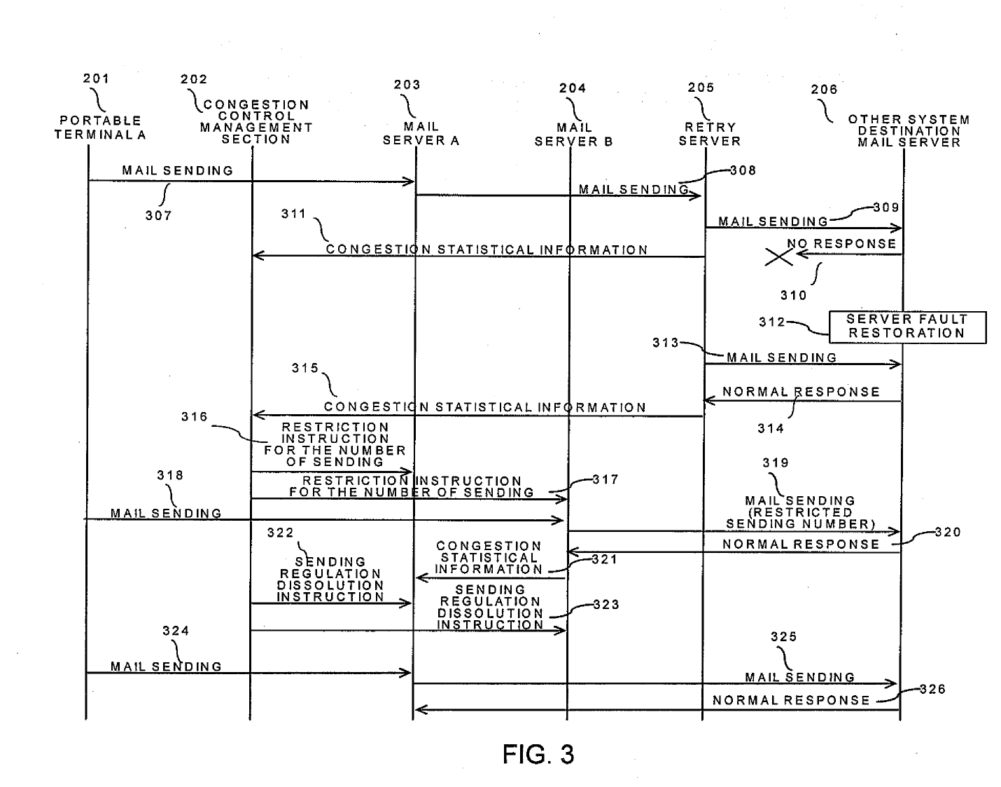

A congestion control with this mail server system in the case where the destination mail server of the other system is recovered from a fault will be described below in accordance with a sequence of FIG. 3.

The mail server A203 having received a mail 307 sent from the portable telephone A201 refers to the regulation information storage section and transfers the received mail to the retry server 205, if the destination designated in the mail is the mail sever 206 having received the sending regulation instruction. The retry server 205 sends 309 the received mail to the destination mail server 206, and sends the congestion statistical information 311 including the average answering time 604 for each destination domain 601, the number of mail sending trail 602 per unit time, and the number of mail sending error 603 to the congestion control management section 202.

Herein, if the other system mail server 206 at the destination is recovered 312 from a fault, the mail 313 sent from the retry sever 205 has a normal response 314, but if the ratio of the number of mail sending error 603 to the number of mail sending trail 602 from the congestion statistical information 315 is below the threshold 2, the congestion control management section 202 sends a restriction instruction for the number of sending 316 or 317 to the mail server 203 or 204. The mail server 203 or 204 receives a sent mail 318 after receiving the restriction instruction for the number of sending, and sends a mail 319 to the other system mail server 206 at the destination, with a normal response 320. If a delay in the response time of the congestion statistical information 321 or the ratio of the number of mail sending error 603 to the number of mail sending trail 602 is below the threshold 1 of regulating the sending restriction, the congestion control management section 202 sends a sending regulation dissolution instruction 322 to the mail server 203 or 204. The mail server 203 or 204 having received the sending regulation dissolution instruction normally sends a mail 325 to the destination mail server for a subsequently sent mail 324. The threshold for regulation or restriction and the threshold in dissolving the regulation or restriction may be different.

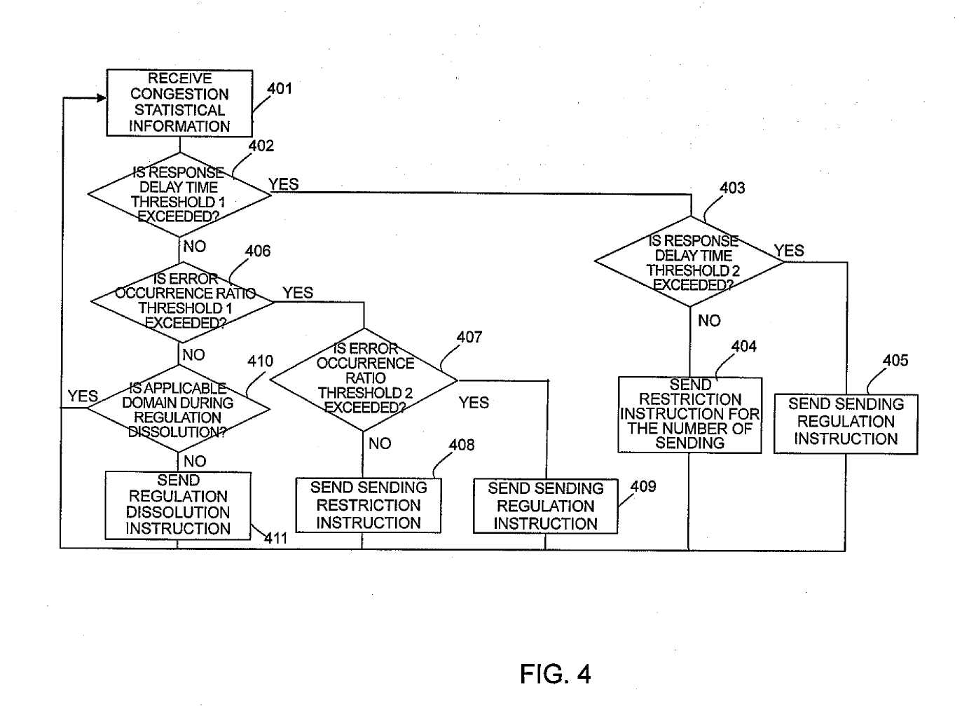

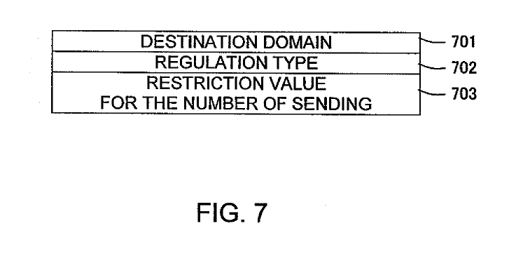

Referring to a flowchart of FIG. 4, a congestion management method for the congestion control, management section 120 of this system will be described below. FIG. 7 is an organization diagram for the congestion control instruction.

The congestion control management section 120 receives 401 the congestion statistical information 210 and determines 402 whether or not the average answering time 604 of the congestion statistical information 210 exceeds the preset response delay time threshold 1. If so, the congestion control management section 120 sends a congestion control instruction 405 set such that a destination domain 701 is the applicable domain 601 and a regulation type 702 is the sending regulation instruction to all the mail servers 120 within the mail server system 101, if the average answering time 604 also exceeds the response delay time threshold 2. On the other hand, if the threshold 2 is not exceeded, the congestion control management section 120 sends a congestion control instruction 404 set such that the destination domain 701 is the applicable domain 601, the regulation type 702 is the restriction instruction for the number of sending and a restriction value for the number of sending 703 is the preset restriction value for the number of sending, together with the preset restriction value for the number of sending.

On the other hand, if the threshold 1 is not exceeded in determination 402 of the response delay time threshold 1, the congestion control management section 120 determines 406 whether or not the ratio of the number of mail sending error 603 to the number of mail sending trail 602 in the congestion statistical information 210 exceeds the preset error occurrence ratio threshold 1. If so, the congestion control management section 120 further determines whether or not the error occurrence ratio threshold 2 is exceeded. If this is also exceeded, the congestion control management section 120 sends a congestion control instruction 409 set such that the destination domain 701 is the applicable domain 601 and the regulation type 702 is the sending regulation instruction to all the mail servers 102 within the mail server system 101. On the other hand, if the threshold 2 is not exceeded, the congestion control management section 120 sends a congestion control instruction 408 set such that the destination domain 701 is the applicable domain 601, the regulation type 702 is the restriction instruction for the number of sending and the restriction value for the number of sending 703 is the preset restriction value for the number of sending.

If the threshold 1 is not exceeded in the determination 406 of the ratio of the sending error number, the congestion control management section 120 determines 410 whether or not the applicable destination is during regulation, and if so, sends a congestion control instruction 411 set such that the destination domain 701 is the applicable domain 601 and the regulation type 702 is the regulation dissolution instruction to all the mail servers 102 within the mail server system 101.

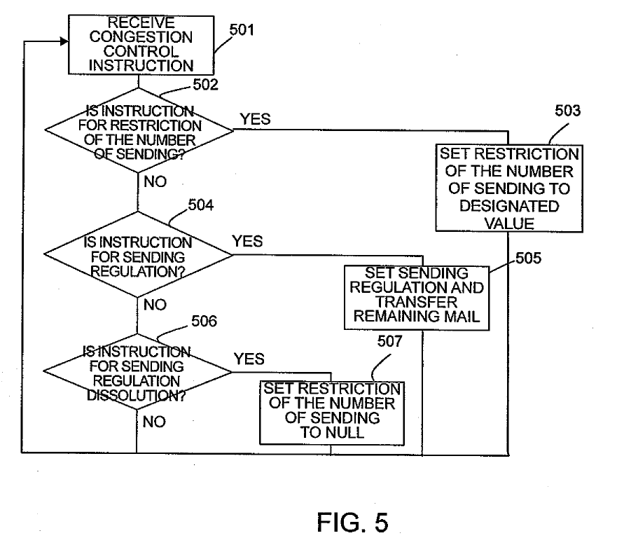

Referring to a flowchart of FIG. 5, a congestion management method for the congestion control section 115 of the mail server 102 in this system will be described below.

If the congestion control section 115 of each mail server receives a congestion control instruction (501), it determines whether or not the regulation type 702 is the restriction for the number of sending (502). If it is the restriction instruction for the number of sending, the congestion control section 115 sets 503 the value designated in the restriction value for the number of sending 703 to the restriction value for the number of sending of the applicable domain 701 (503). If the regulation type is not the restriction for the number of sending, the congestion control section 115 determines whether or not the regulation type 702 is the sending regulation instruction (504). If it is the sending regulation instruction, the congestion control section 115 regulates sending to the applicable domain 701. If the regulation type is not the sending regulation, the congestion control section 115 determines whether or not the regulation instruction 702 is the regulation dissolution (506). If it is the regulation dissolution instruction, the congestion control section 115 issolves the sending regulation for the applicable domain 701. The destination domain, regulation type and restriction value for the number of sending may be set as shown in FIG. 8, for example.

The invention is applicable to a mail system for providing a service of allowing a carrier to send a mail from a subscribing user to the other carrier or other user.

What is claimed is:

1. A mail server system comprising:
a plurality of mail servers which are redundantly configured and sends a received electronic mail according to a destination thereof;
a retry server for performing a resend process for the electronic mail transferred from the mail servers; and
a congestion control management section for judging whether or not to regulate a sending by comparing response time information or a ratio of the number of errors to the number of mail sending trial with a preset threshold, based on the congestion statistical information received for each destination domain, and sending a sending regulation instruction including the destination domain to each of the plurality of mail servers in a case of regulating the sending;
each of the plurality of mail servers having:
a statistical information collection section for collecting the response time information of the destination domain and/or the error ratio information including the number of mail sending trail and the number of errors for each destination domain of electronic mail, and sending the congestion statistical information including the response time information and/or the error ratio information to the congestion control management section; and
a congestion control section for receiving a sending regulation instruction from the congestion control management section and transferring an electronic mail directed to the destination domain included in the sending regulation instruction to the retry server.

2. The mail server system according to claim 1, wherein the congestion control management section sends the sending regulation instruction if the response time information exceeds the preset threshold.

3. The mail server system according to claim 1, wherein the congestion control management section sends the sending regulation instruction if the ratio of the number of errors to the number of mail sending trial exceeds the preset threshold.

4. The mail server system according to claim 1, wherein the mail server, upon receiving the sending regulation instruction, transfers the electronic mail directed to the destination domain included in the sending regulation instruction and left in a resend queue of the self server to the retry server without performing the resend process.

5. The mail server system according to claim 1, wherein the mail server stores the destination domain included in the sending regulation instruction, and upon receiving the electronic mail during the sending regulation, determines whether or not the destination of the electronic mail is a stored destination domain and transfers the electronic mail directed to the stored destination domain to the retry server.

6. The mail server system according to claim 1, wherein the congestion control management section judges whether or not to restrict the number of sending by comparing the response time information or the ratio of the number of errors to the number of mail sending trial with a preset second threshold, and sends a restriction instruction for the number of sending including the destination domain to each of the plurality of mail servers in a case of restricting the number of sending, and
the mail server restricts the number of sending the electronic mails to the destination domain included in the restriction instruction for the number of sending.

7. The mail server system according to claim 1, wherein
the retry server has a second statistical information collection section for collecting the response time information of the destination domain and/or the error ratio information including the number of mail sending trial and the number of errors for each destination domain of the electronic mail, and sending the congestion statistical information including the response time information and/or the error ratio information to the congestion control management section in the resend process for transferred electronic mail, and
the congestion control management section judges whether or not to dissolve the sending regulation by comparing the response time information, or the ratio of the number of errors to the number of mail sending trial with a preset third threshold, based on the congestion statistical information received for each destination domain, and sending a sending regulation dissolution instruction including the destination domain to each of the plurality of mail servers in a case of dissolving the sending regulation.

8. The mail server system according to claim 1, wherein the congestion control management section is arranged in the retry server.

9. A congestion control method in a mail server system which comprises a plurality of mail servers which are redundantly configured and sends a received electronic mail according to a destination thereof and, a retry server for performing a resend process for the electronic mail transferred from the mail servers, the congestion control method comprising steps of:
collecting, by a mail server, the response time information of the destination domain and/or the error ratio information including the number of mail sending trail and the number of errors for each destination domain of electronic mail, and sending the congestion statistical information including the response time information and/or the error ratio information;
judging whether or not to regulate a sending by comparing response time information or a ratio of the number of errors to the number of mail sending trial with a preset threshold, based on the congestion statistical information received for each destination domain, and sending a sending regulation instruction including the destination domain to each of the plurality of mail servers in a case of regulating the sending;
receiving, by the mail server, the sending regulation instruction and transferring an electronic mail directed to the destination domain included in the sending regulation instruction to the retry server; and
performing, by the retry server, the resend process for the electronic mail transferred.
